(19) United States
(12) Patent Application Publication
(10) Pub. No.: US 2012/0143929 A1
(43) Pub. Date: Jun. 7, 2012

(54) VIRTUALIZED OPERATING SYSTEM ENVIRONMENT FILE-SYSTEM

(75) Inventors: KAVITHA VITTAL MURTHY BARATAKKE, Austin, TX (US); Nikhil Hegde, Austin, TX (US); David William Sheffield, Austin, TX (US); Dilip Kumar Singh, Bangalore (IN)

(73) Assignee: International Business Machines Corporation, Armonk, NY (US)

(21) Appl. No.: 12/959,082

(22) Filed: Dec. 2, 2010

(51) Int. Cl. G06F 17/30

(52) U.S. Cl. 707/827; 707/E17.01

(57) ABSTRACT

A method, system, and computer program product for an improved virtualized operating system environment file-system are provided in the illustrative embodiments. A computer receives a write request for a part in the virtualized operating system environment file-system. The computer determines whether the part in the virtualized operating system environment file-system is a link to a second part in a host file-system. The computer, responsive to the part in the virtualized operating system environment file-system being the link, replaces the link with content of the second part the content replacing the link forming a writable copy of the part.

### BACKGROUND

1. Technical Field

The present invention relates generally to a computer implemented method, system, and computer program product for operating virtual operating system environments in a data processing system. More particularly, the present invention relates to a computer implemented method, system, and computer program product for an improved virtualized operating system environment file-system.

2. Description of the Related Art

A data processing system uses an operating system (OS) to perform the data processing system's functions. Certain data processing systems can be configured to host virtual environments within the data processing system such that each virtual environment appears to be a separate data processing system distinct from the host data processing system.

Typically, the virtual environment does not include a separate operating system but uses the same operating system kernel as the host data processing system. Operations performed by users and applications in such a virtualized operating system environment are eventually directed to the host operating system for execution.

Workload partition is one technology that allows separating users and applications by employing software techniques instead of forming separate hardware partitions. In other words, a data processing system can be so configured as to allow one or more virtual partitions to operate within the data processing system's operating system. Such a virtual partition is called a workload partition, or WPAR.

A WPAR shares the operating system and resources of the host data processing system. Resources accessible to the operating system of the host data processing system are said to belong to a “global space”. In other words, a resource in the global space can be accessed by the operating system of the host data processing system.

An application executing in a WPAR may use the WPAR as if the WPAR were a complete data processing system. The application executes in the WPAR without the awareness that the WPAR, and consequently the application, is sharing resources in the global space of the host data processing system. More than one WPAR may share resources in the global space.

A WPAR is configured, started, operated, and eventually terminated in a host data processing system using resources in the global space. Resources utilized by the WPAR during these various stages remain visible, available, and accessible to the operating system of the host data processing system.

WPARs are commonly employed for separating applications, functions, or functionalities from one another. The separation may be desirable for a variety of reasons, such as security, performance, portability, or administrative concerns.

For example, a desirable feature of a banking application may be to separate the back-office functions from the web-user functions. Such a separation may be achieved by implementing the back-office functions and the web-user functions in a manner that they can be executed on different WPARs.

A WPAR can be addressed over a network just like a complete stand-alone data processing system. In other words, each WPAR in a host data processing system and the host data processing system itself can have unique network address. Thus, a host data processing system with several WPARs configured thereon appears as a collection of network addresses on a network as if a distinct data processing system is associated with each address.

### SUMMARY

The illustrative embodiments provide a method, system, and computer program product for an improved virtualized operating system environment file-system. An embodiment receives a write request for a part in the virtualized operating system environment file-system. The embodiment determines whether the part in the virtualized operating system environment file-system is a link to a second part in a host file-system. The embodiment, responsive to the part in the virtualized operating system environment file-system being the link, replaces the link with content of the second part, the content replacing the link forming a writable copy of the part.

Another embodiment includes one or more computer-readable, tangible storage devices. The embodiment further includes program instructions, stored on at least one of the one or more storage devices, to receive a write request for a part in the virtualized operating system environment file-system. The embodiment further includes program instructions, stored on at least one of the one or more storage devices, to determine whether the part in the virtualized operating system environment file-system is a link to a second part in a host file-system. The embodiment further includes program instructions, stored on at least one of the one or more storage devices, responsive to the part in the virtualized operating system environment file-system being the link, to replace the link with content of the second part, the content replacing the link forming a writable copy of the part.

Another embodiment includes one or more processors, one or more computer-readable memories and one or more computer-readable, tangible storage devices. The embodiment further includes program instructions, stored on at least one of the one or more storage devices for execution by at least one of the one or more processors via at least one of the one or more memories, to receive a write request for a part in the virtualized operating system environment file-system. The embodiment further includes program instructions, stored on at least one of the one or more storage devices for execution by at least one of the one or more processors via at least one of the one or more memories, to determine whether the part in the virtualized operating system environment file-system is a link to a second part in a host file-system. The embodiment further includes program instructions, stored on at least one of the one or more storage devices for execution by at least one of the one or more processors via at least one of the one or more memories, responsive to the part in the virtualized operating system environment file-system being the link, to replace the link with content of the second part, the content replacing the link forming a writable copy of the part.

### BRIEF DESCRIPTION OF THE SEVERAL VIEWS OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of a virtualized operating system environment file-system configuration in which an illustrative embodiment may be implemented;

FIG. 4 depicts a block diagram of an improved virtualized operating system environment file-system in accordance with an illustrative embodiment;

FIG. 5 depicts a block diagram of an example process of intelligent replacement of links in an improved virtualized operating system environment file-system in accordance with an illustrative embodiment; and

FIG. 6 depicts a flowchart of an example process of using an improved virtualized operating system environment file-system, including intelligent replacement of links in the improved virtualized operating system environment file-system, in accordance with an illustrative embodiment.

### DETAILED DESCRIPTION

Presently, a virtualized operating system environment within a single instance of the host operating system shares a common kernel such that variations from the host operating system environment are typically limited within the virtualized operating system environment. In some instances, a virtualized operating system environment, such as a WPAR, has to operate using legacy—older—OS features. For example, the host OS may be at version 7.1 of the particular OS, whereas certain applications to be executed within a WPAR under that host may require the functionality of OS version 5.2. A Compatibility Runtime Environment (CRE) is a virtualized operating system environment that is enabled to operate using a legacy OS environment. A CRE WPAR is a WPAR constructed as a CRE. A native WPAR is a WPAR not constructed as a CRE, i.e., when the WPAR uses the same version of the OS as the host OS.

A CRE abstracts the kernel interface so that a different OS version may be presented within the CRE virtualized operating system environment. Presently, without the benefit of an embodiment of the invention, a CRE virtualized operating system environment, such as a CRE WPAR, uses a file-system that is distinct from the host environment's file-system. For example, presently a CRE WPAR's file-system is created in a separate disk space, is detached from the host environment's file-system, and mounted separately in the CRE WPAR.

A native WPAR may also require a file-system that is private, or separate, from the host environment's file-system. Accordingly, a private WPAR is a native WPAR whose file-system is created in a separate disk space, is detached from the host environment's file-system, and mounted separately in the native WPAR.

For the remainder of the disclosure, a CRE WPAR will be used as an example virtualized operating system environment for the clarity of the description, without limiting the invention or an embodiment thereof to CRE WPARs. Any embodiment described with respect to a WPAR or a CRE WPAR in particular, may be implemented using other virtualized operating system environments with similar needs, such as for example, in a native WPAR having a private file-system.

Generally, when a WPAR is created, the global system—the host OS—creates a new file-system which includes directories such as “/”, “/usr”, “/etc”, and “/tmp” for that WPAR. When the WPAR is started, the global system mounts this newly created file-system, or directories, there under in the WPAR.

As an example, presently, a CRE WPAR uses a detached “/usr” directory in the file-system which stores all files for a legacy OS version. The kernel interface of the host OS is abstracted so that the legacy semantic is provided to the CRE WPAR and the native semantic is presented to native WPARs and the global (host) environment. The legacy kernel application program interface (API) is analyzed to determine how that legacy kernel API has changed over time, and support is added to account for any differences between the legacy OS version and the host OS version. Such support may include, for example, changed or different arguments, secondary structures, and return codes.

Generally, a CRE WPAR uses a “cmds” and “libs” directories in file-system that is compatible with the legacy OS version, in conjunction with a global operating system file-system that may be compatible with a later version of the OS used in the host environment. For example, presently this structuring of the two separate file-systems is accomplished by configuring the host system with a CRE WPAR and installing a mksysb image of the legacy OS on the CRE WPAR. Thus, applications installed inside a particular CRE WPAR can execute using the legacy OS version (cmds and libs) but on a newer kernel. As described above, the later version kernel interface is abstracted so that the legacy semantic is provided to CRE WPARs.

The invention recognizes that creating WPARs, native WPARs, CRE WPARs, and virtualized operating system environments in general causes multiple distinct file-systems to be created. For example, for native WPARs and CRE WPARs, the /usr directory in their file-system is always private, i.e., their /usr directory occupies file-system space separate from the file-system space of the host environment. For the native WPAR, the /usr directory is populated with the commands and libraries from the same OS level as that hosted by the global system. For CRE WPAR's, the /usr directory is populated with the commands and libraries from a mksysb image of a legacy version of the OS.

The invention recognizes that creating separate file-systems in this manner occupies data storage space. Creating a new virtualized operating system environment duplicates a significant amount of data that is similar between the host environment and the virtualized operating system environment. The invention recognizes that creating file-systems for virtualized operating system environments in this manner is inefficient and wasteful of computing resources. Even when multiple virtualized operating system environments operate using a common legacy OS version, their file-systems have to be created separately, duplicating even the files that could be common among the virtualized operating system environments' file-systems.

The illustrative embodiments used to describe the invention generally address and solve the above-described problems and other problems related to operating virtualized operating system environments. The illustrative embodiments provide a method, system, and computer program product for an improved virtualized operating system environment file-system.

According to an embodiment of the invention, an improved virtualized operating system environment file-system includes data for some parts of the virtualized operating system environment file-system and links to other parts of the host environment's file-system. According to an embodiment, the parts of the improved virtualized operating system environment file-system that are populated with actual data, such as writable files or executable libraries, are parts that are different from comparable parts in the host environment's file-system, non-existent in the host environment's file-system, updated or modified by the virtualized operating system environment, or a combination thereof. The parts of the improved virtualized operating system environment file-system that are represented as links to parts of the host file-system are those parts, such as files or libraries, that are unchanged between the virtualized operating system environment file-system and the host file-system.

The illustrative embodiments are described with respect to certain data, data structures, file-systems, file names, directories, and paths only as examples. Such descriptions are not intended to be limiting on the invention. For example, an illustrative embodiment described with respect to hyperlink type of links may be implemented using another type of link or redirect within the scope of the invention.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are further described with respect to certain applications only as examples. Such descriptions are not intended to be limiting on the invention. An embodiment of the invention may be implemented with respect to any type of application, such as, for example, applications that are served, the instances of any type of server application, a platform application, a stand-alone application, an administration application, or a combination thereof.

An application may further include data objects, code objects, encapsulated instructions, application fragments, services, and other types of resources available in a data processing environment. For example, a Java® object, an Enterprise Java Bean (EJB), a servlet, or an applet may be manifestations of an application with respect to which the invention may be implemented. (Java and all Java-based trademarks and logos are trademarks or registered trademarks of Oracle and/or its affiliates).

An illustrative embodiment may be implemented in hardware, software, or a combination thereof. An illustrative embodiment may further be implemented with respect to any type of data storage resource, such as a physical or virtual data storage device, that may be available in a given WPAR configuration.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

The illustrative embodiments are described using specific code, designs, architectures, layouts, schematics, and tools only as examples and are not limiting on the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

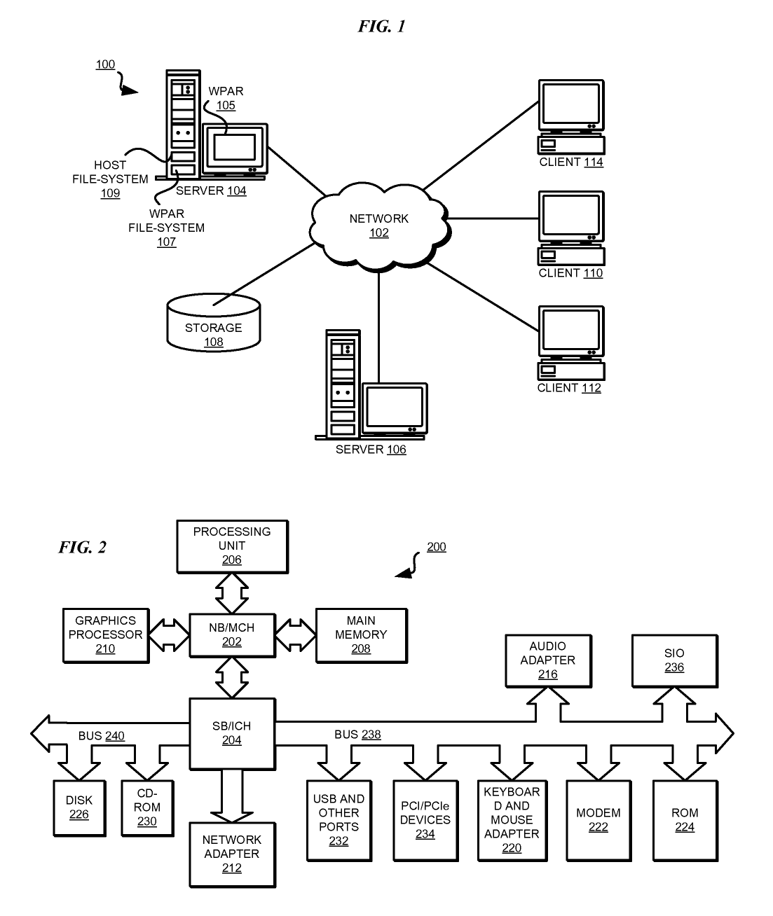

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Server 104 may include any number of WPARs, such as WPAR 105, and any number of WPAR file-systems, such as WPAR file-system 107. WPAR 105 may be a virtualized operating system environment of any kind, including but not limited to a CRE WPAR or a native WPAR. Server 104 may further include host file-system 109. Host file-system 109 may be the file-system used by server 104's global environment.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes of the illustrative embodiments may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States, other countries, or both), or Linux® (Linux is a trademark of Linus Torvalds in the United States, other countries, or both). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle and/or its affiliates).

Program instructions for the operating system, the object-oriented programming system, the processes of the illustrative embodiments, and applications or programs are located on storage devices, such as hard disk drive 226, and may be loaded into a memory, such as, for example, main memory 208, read only memory 224, or one or more peripheral devices, for execution by processing unit 206.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

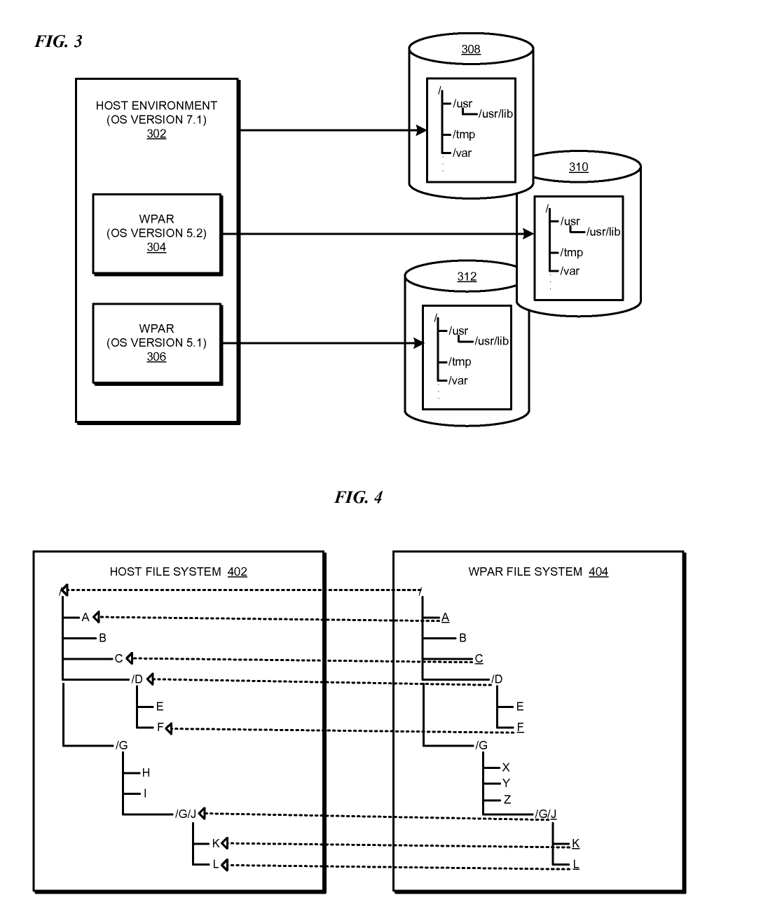

With reference to FIG. 3, this figure depicts a block diagram of a virtualized operating system environment file-system configuration in which an illustrative embodiment may be implemented. Host environment 302 may be the operating system of a certain version available in a host data processing system, such as server 104 in FIG. 1. As an example, assume that host environment 302 is using OS version 7.1 of a particular OS as shown. WPAR 304 may be a CRE WPAR at one legacy version, and WPAR 306 may be another CRE WPAR at another legacy version. To illustrate, WPAR 304 is shown to be using version 5.2 of the OS of which the host environment is using version 7.1. Similarly, for example, WPAR 306 is shown to be using version 5.1 of that OS. In another example, again assuming that host environment 302 is using OS version 7.1 of a particular OS as shown, WPAR 304 and WPAR 306 may be private WPARs also using OS version 7.1 of the particular OS.

Host environment 302's host file-system is depicted as stored in data storage device 308. WPAR 304's file-system is stored in data storage device 310, and WPAR 306's file-system is stored in data storage device 312. Data storage devices 308, 310, and 312 may be different devices, or different storage areas of a common storage device.

As depicted, host environment 302, WPAR 304, and WPAR 306 each include separate directories and files in their respective file-systems. For example, each of storage devices 308, 310, and 312 include a root directory “/”, a usr directory “/usr”, a lib directory “/usr/lib”, and many other directories. Furthermore, each such directory is populated with the actual data, such as files and libraries, needed to use the particular OS version in the corresponding host or virtualized operating system environment.

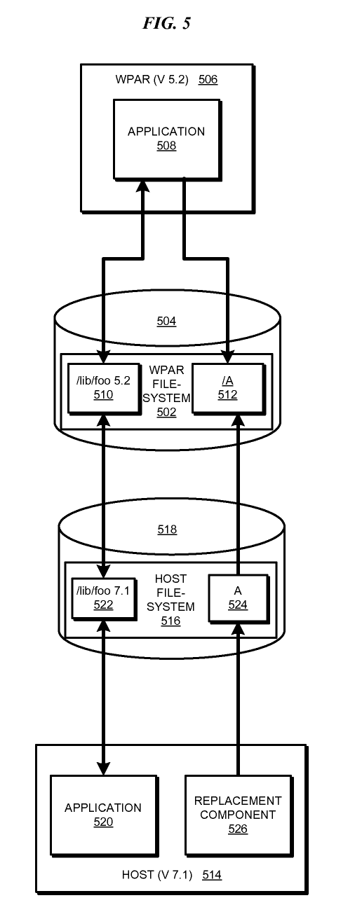

With reference to FIG. 4, this figure depicts a block diagram of an improved virtualized operating system environment file-system in accordance with an illustrative embodiment. Host file-system 402 may be similar to the file-system stored in data storage device 308 for host environment 302 in FIG. 3. WPAR file-system 404 is an example of an improved virtualized operating system environment file-system according to an embodiment and may be usable in place of WPAR 304's file-system stored in data storage device 310 in FIG. 3.

In a first embodiment, host file-system 402 includes parts, such as data, objects (e.g., directories), or files, that may be suitable for using the host's OS version. According to such first embodiment, if the operating system of the host is OS version 7.1, the /usr directory in host file-system 402 will include those files and data that are needed for using OS version 7.1. Other parts of host file-system 402, such as the contents of other directories, follow similar logic for inclusion.

In a second embodiment, host file-system 402 additionally includes the parts needed for using other supported legacy versions of the OS. For example, the host may be using OS version 7.1 and versions 5.x and 6.x are the legacy versions that are supported for virtualized operating system environments. According to such second embodiment, the /usr directory in host file-system 402 will include those files and data that are needed for using OS version 7.1, and those files and data that are needed for using any of the 5.x or 6.x OS versions. Other parts of host file-system 402, such as the contents of other directories, follow similar logic for inclusion.

Regardless of which of the above embodiments is selected, certain parts of host file-system 402 may be reusable as comparable parts in WPAR file-system 404. In other words, some parts may be compatible with host file-system 402 as well as WPAR file-system 404. For example, if the first embodiment is used, and WPAR file-system 404 is of a CRE WPAR using OS version 5.2, at least those files or data that have not changed between versions 5.2 and 7.1 are reusable from host file-system 402 into WPAR file-system 404. Accordingly, at least those parts can be referenced from WPAR file-system 404 into host file-system 402 without having to copy those parts into WPAR file-system 404, thus saving data storage space. In another example, if the first embodiment is used, and WPAR file-system 404 is of a private WPAR using OS version 7.1, all files are reusable from host file-system 402 into WPAR file-system 404. Accordingly, all of those parts can be referenced from WPAR file-system 404 into host file-system 402 without having to copy those parts into WPAR file-system 404, thus saving data storage space.

As another example, if the second embodiment is used, and WPAR file-system 404 is of a CRE WPAR using OS version 5.2, all the files or data needed for WPAR file-system 404 corresponding to OS version 5.2 are included in host file-system 402, and can therefore be referenced from, or followable from, WPAR file-system 404 into host file-system 402 instead of copying into WPAR file-system 404, thus storing data storage space.

Only as an example for the clarity of the illustration, host file-system 402 is depicted as including a (root)/directory with files A, B, and C, and directories /D and /G. The /D directory in host file-system 402 is depicted to further include files E and F. The /G directory in host file-system 402 is depicted to further include files H and I and a subdirectory /G/J having files K and L.

In accordance with an embodiment, WPAR file-system 404 may be configured to include links to certain parts in host file-system 402, actual contents of certain parts, or a combination thereof. For example, WPAR file-system 404's (root)/directory can be a link to host file-system 402's (root)/directory such that when an application executing in a WPAR that uses WPAR file-system 404 accesses (root)/directory in WPAR file-system 404, host file-system 402's (root)/directory provides the requested part.

Furthermore, not all the parts in WPAR file-system 404 need be linked to parts in host file-system 402 in this manner. For example, file A may be common between host file-system 402 and WPAR file-system 404 and may be represented by a link “A-underline” (A) in WPAR file-system 404 referencing file A in host file-system 402, but file B in WPAR file-system 404 may be an actual file that is different from file B in host file-system 402. A link may have the same name as the original file within the scope of the invention. The underlined names are used only for the clarity of the illustration without imposing any limitation on the invention.

Similarly, file C may be linked by placing link “C-underline” (C) in WPAR file-system 404 referencing file C in host file-system 402. Directory D may include actual different files E in each file-system, whereas file F may be linked by placing link “F-underline” (F) in WPAR file-system 404 referencing file F in host file-system 402.

Directory /G in WPAR file-system 404 may include files X, Y, and Z not present in directory /G in host file-system 402. Subdirectory /G/J may contain similar parts K and L in both file-systems, and therefore may be represented by a link “/G/J-underline” (/G/J) in WPAR file-system 404 referencing subdirectory /G/J in host file-system 402. Parts K and L in host file-system 402 may be similarly referenced using links “K-underline” (K) and “L-underline” (L) in WPAR file-system 404.

Thus, using an embodiment, WPAR file-system 404 can be formed to use less data storage space than a file-system for similar use using presently available methods. The names, types, and organization of the depicted parts are only examples and are not intended to be limiting on the invention. One of ordinary skill in the art will appreciate that any of the depicted parts, such as directories, subdirectories, files, data, or other structures, can bear any name or content suitable for a given implementation without departing the scope of the invention.

During operation, a need may arise to update or modify a part that is referenced by a link from WPAR file-system 404 to host file-system 402. The link to the actual part has to be intelligently replaced with the contents of the part such that the operation of the WPAR is not affected and the part in host file-system 402 is not updated by the WPAR's operation. An embodiment provides the mechanism for such an intelligent replacement.

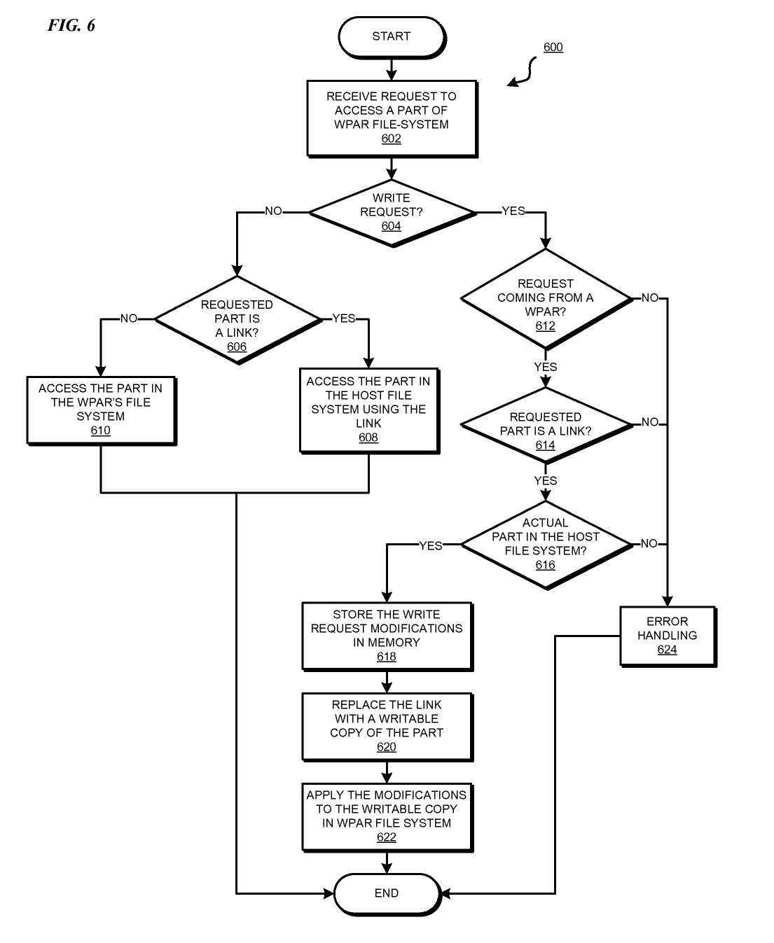

With reference to FIG. 5, this figure depicts a block diagram of an example process of intelligent replacement of links in an improved virtualized operating system environment file-system in accordance with an illustrative embodiment. WPAR file-system 502 is analogous to WPAR file-system 404 in FIG. 4. Host file-system 516 is analogous to host file-system 402 in FIG. 4.

WPAR 506, which for example, may be using legacy OS version 5.2 of a given host OS, uses WPAR file-system 502 stored in data storage 504. Application 508 may be an application executing in WPAR 506 and accessing WPAR file-system 502. For example, application 508 may call API 510 “/lib/foo5.2”, or access link “A-underline” (A) 512 in the root directory of WPAR file-system 502 to part /A 524 in host file-system 516.

Host environment 514 may be using, for example, OS version 7.1, and may use host file-system 516 stored in data storage device 518. Application 520 executing in host environment 514 may call API 522 such as “/lib/foo7.1” function, which may be a modified version of API 510 “/lib/foo5.2”.

When application 508 requests to modify part “/A” of WPAR file-system 502, application 508 in effect requests to modify part /A 524 in host file-system 516 via link “/A-underline” (A) 512 in WPAR file-system 502. Replacement component 526 executing in host environment 514 detects that a WPAR is attempting to modify a part of host file-system 516. Replacement component 526 causes a writable copy of part /A 524 from host file-system 516 to replace link “/A-underline” (A) 512 in WPAR file-system 502. Application 508′s request to modify part “/A” then proceeds against the writable copy of part /A 524 that replaces link 512.

Calls to WPAR APIs, such as application 508's call to API 510 “/lib/foo5.2” is handled using a similar principle, albeit the nature of the API links is different in the following manner. As described, API 522 may be a modified version of API 510. As such, API 510 is created as a link to API 522 such that when application 508 calls API 510 with API 510′s semantics, API 510's implementation invokes API 522 with API 522's semantics.

API 522 is implemented to recognize whether API 522 is being called from application 520 in host environment 514 or by application 508 in WPAR 506. When called by application 520, API 522 returns data suitable for application 520 using OS version 7.1 of the host. When called from application 508, API 522 returns to API 510 data that can be used by application 508 executing under OS version 5.2. API 510 in turn sends the data in response to application 508's call to API 510.

If multiple WPARs 506 are operating in host environment 514, each WPAR 506′s file-system 502 would be separate but smaller than possible with currently available methods, and would operate in the above described manner. Operating in this manner, WPAR file-system 502 occupies smaller data storage space than possible with currently available methods and avoids unnecessary replication of data from host to WPAR or for multiple WPARs.

With reference to FIG. 6, this figure depicts a flowchart of an example process of using an improved virtualized operating system environment file-system, including intelligent replacement of links in the improved virtualized operating system environment file-system, in accordance with an illustrative embodiment. Process 600 may be implemented in a WPAR file-system 502, replacement component 526 of host environment 514, or a combination thereof, in FIG. 5.

Process 600 begins by receiving a request to access a part of a WPAR file-system (block 602). Process 600 determines whether the request is for writing to the part, such as for an update, addition, deletion, or other modification (block 604). If the request is not for writing to the part (“No” path of block 604), process 600 determines whether the requested part exists as a link in the WPAR file-system (block 606).

If the part exists as a link in the WPAR file-system (“Yes” path of block 606), process 600 accesses the part in the host file-system using the link (block 608). If the part exists as the actual part with content in the WPAR file-system (“No” path of block 606), process 600 accesses the part in the WPAR file-system (block 610). Process 600 completes the request (not shown) and ends thereafter.

Returning to block 604, if process 600 determines that the request is for writing to the part (“Yes” path of block 604), process 600 determines whether the request is coming from a valid WPAR in the host environment (block 612). A valid WPAR may be any WPAR recognized by the host environment as authorized to operate in the host environment at the time of sending the request.

If the request is from a valid WPAR (“Yes” path of block 612), process 600 determines whether the request invoked a valid link in the WPAR's file-system (block 614). If the request had invoked a valid link (“Yes” path of block 614), process 600 determines whether the requested actual part exists in the host file-system (block 616).

If the actual part exists in the host file-system (“Yes” path of block 616), process 600 causes a storing of the request's requested modifications to the part in memory (block 618). Process 600 replaces the link in the WPAR file-system with a writable copy of the actual part from the host file-system (block 620). Process 600 causes application of the stored modifications from the memory to the writable copy in the WPAR file-system (block 622). Process 600 ends thereafter.

If the request is not from a valid WPAR (“No” path of block 612), or if the request did not invoke a valid link (“No” path of block 614), or if the actual part does not exist in the host file-system (“No” path of block 616), process 600 may trigger any suitable error handling (block 624), and end thereafter.

Note that the conditions in blocks 612, 614, and 616 are depicted and described only as an example suitable for a particular implementation. Those of ordinary skill in the art will appreciate that fewer conditions, or additional or different conditions, can be similarly used within the scope of the invention for the link to be replaced with the writable copy of a part in the WPAR file-system.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for an improved virtualized operating system environment file-system. Using an embodiment of the invention, a virtualized operating system environment's file-system can be created such that the file-system occupies a smaller space on a data storage device, avoids unnecessary duplication of data, and provides intelligent replacement of links with actual data as needed.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for using an improved virtualized operating system environment file-system, the method comprising:
a computer receiving a write request for a part in the virtualized operating system environment file-system;
the computer determining whether the part in the virtualized operating system environment file-system is a link to a second part in a host file-system; and
the computer, responsive to the part in the virtualized operating system environment file-system being the link, replacing the link with content of the second part, the content replacing the link forming a writable copy of the part.

2. The method of claim 1, further comprising:
the computer storing a modification requested by the write request in memory before replacing the link with the content of the second part; and
the computer applying the stored modification to the writable copy after replacing the link with the content of the second part.

3. The method of claim 1, further comprising:
the computer determining whether a part in a host file-system is compatible in the virtualized operating system environment file-system; and
the computer creating a link to the part in the host file-system in the virtualized operating system environment file-system responsive to the determination that the part in the host file-system is compatible in the virtualized operating system environment file-system, the link being followable by an application executing in the virtualized operating system environment to access the part.

4. The method of claim 1, further comprising:
the computer determining whether a part in a host file-system is compatible in the virtualized operating system environment file-system; and
the computer populating, responsive to the determination that the part in the host file-system is not compatible in the virtualized operating system environment file-system, the part with content in the virtualized operating system environment file-system such that the content is followable by an application executing in the virtualized operating system environment under a version of the virtualized operating system environment's operating system.

5. The method of claim 1, further comprising:
the computer determining whether the request originated from a virtualized operating system environment that is recognized by a host environment of the host file-system as being authorized to operate in the host environment at a time of sending the request; and
the computer proceeding with the replacing responsive to the request having originated from the valid virtualized operating system environment.

6. The method of claim 1, further comprising:
the computer determining whether the request invoked a valid link; and
the computer proceeding with the replacing responsive to the request having invoked the valid link.

7. The method of claim 1, further comprising:
the computer determining whether the second part exists in the host file-system; and
the computer proceeding with the replacing responsive to the second part existing in the host file-system.

8. The method of claim 1, further comprising:
the computer creating the virtualized operating system environment file-system including the link at the initiation of the virtualized operating system environment.

9. A computer program product comprising one or more computer-readable, tangible storage devices and computer-readable program instructions which are stored on the one or more storage devices and when executed by one or more processors, perform the method of claim 1.

10. A computer system comprising one or more processors, one or more computer-readable memories, one or more computer-readable, tangible storage devices and program instructions which are stored on the one or more storage devices for execution by the one or more processors via the one or more memories and when executed by the one or more processors perform the method of claim 1.

11. A computer program product for using an improved virtualized operating system environment file-system, the computer program product comprising:
one or more computer-readable, tangible storage devices;
program instructions, stored on at least one of the one or more storage devices, to receive a write request for a part in the virtualized operating system environment file-system;
program instructions, stored on at least one of the one or more storage devices, to determine whether the part in the virtualized operating system environment file-system is a link to a second part in a host file-system; and
program instructions, stored on at least one of the one or more storage devices, responsive to the part in the virtualized operating system environment file-system being the link, to replace the link with content of the second part, the content replacing the link forming a writable copy of the part.

12. The computer program product of claim 11, further comprising:
program instructions, stored on at least one of the one or more storage devices, to store a modification requested by the write request in memory before replacing the link with the content of the second part; and
program instructions, stored on at least one of the one or more storage devices, to apply the stored modification to the writable copy after replacing the link with the content of the second part.

13. The computer program product of claim 11, further comprising:
program instructions, stored on at least one of the one or more storage devices, to determine whether a part in a host file-system is compatible in the virtualized operating system environment file-system; and
program instructions, stored on at least one of the one or more storage devices, to create a link to the part in the host file-system in the virtualized operating system environment file-system responsive to the determination that the part in the host file-system is compatible in the virtualized operating system environment file-system, the link being followable by an application executing in the virtualized operating system environment to access the part.

14. The computer program product of claim 11, further comprising:
program instructions, stored on at least one of the one or more storage devices, to determine whether a part in a host file-system is compatible in the virtualized operating system environment file-system; and
program instructions, stored on at least one of the one or more storage devices, to populate, responsive to the determination that the part in the host file-system is not compatible in the virtualized operating system environment file-system, the part with content in the virtualized operating system environment file-system such that the content is followable by an application executing in the virtualized operating system environment under a version of the virtualized operating system environment's operating system.

15. The computer program product of claim 11, further comprising:
program instructions, stored on at least one of the one or more storage devices, to determine whether the request originated from a virtualized operating system environment that is recognized by a host environment of the host file-system as being authorized to operate in the host environment at a time of sending the request; and
program instructions, stored on at least one of the one or more storage devices, to proceed with the replacing responsive to the request having originated from the valid virtualized operating system environment.

16. The computer program product of claim 11, wherein the program instructions are stored in the one or more computer-readable tangible storage devices in a data processing system, and wherein the program instructions are transferred over a network from a remote data processing system.

17. The computer program product of claim 11, wherein the program instructions are stored in the one or more computer-readable tangible storage devices in a server data processing system, and wherein the program instructions are downloaded over a network to a remote data processing system for use in a computer-readable tangible storage device associated with the remote data processing system.

18. A computer system for using an improved virtualized operating system environment file-system, the computer system comprising:
one or more processors, one or more computer-readable memories and one or more computer-readable, tangible storage devices;
program instructions, stored on at least one of the one or more storage devices for execution by at least one of the one or more processors via at least one of the one or more memories, to receive a write request for a part in the virtualized operating system environment file-system;
program instructions, stored on at least one of the one or more storage devices for execution by at least one of the one or more processors via at least one of the one or more memories, to determine whether the part in the virtualized operating system environment file-system is a link to a second part in a host file-system; and
program instructions, stored on at least one of the one or more storage devices for execution by at least one of the one or more processors via at least one of the one or more memories, responsive to the part in the virtualized operating system environment file-system being the link, to replace the link with content of the second part, the content replacing the link forming a writable copy of the part.

19. The computer system of claim 18, further comprising:
program instructions, stored on at least one of the one or more storage devices for execution by at least one of the one or more processors via at least one of the one or more memories, to store a modification requested by the write request in memory before replacing the link with the content of the second part; and
program instructions, stored on at least one of the one or more storage devices for execution by at least one of the one or more processors via at least one of the one or more memories, to apply the stored modification to the writable copy after replacing the link with the content of the second part.

20. The computer system of claim 18, further comprising:
program instructions, stored on at least one of the one or more storage devices for execution by at least one of the one or more processors via at least one of the one or more memories, to determine whether a part in a host file-system is compatible in the virtualized operating system environment file-system; and
program instructions, stored on at least one of the one or more storage devices for execution by at least one of the one or more processors via at least one of the one or more memories, to create a link to the part in the host file-system in the virtualized operating system environment file-system responsive to the determination that the part in the host file-system is compatible in the virtualized operating system environment file-system, the link being followable by an application executing in the virtualized operating system environment to access the part.
